(19) United States
(12) Patent Application Publication
(10) Pub. No.: US 2007/0250613 A1
(43) Pub. Date: Oct. 25, 2007

(54) METHOD AND APPARATUS FOR CONFIGURING A WORKFLOW

(75) Inventor: ROBERT GULLEDGE, ST. CHARLES, MO (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., Reno, NV (US)

(21) Appl. No.: 11/380,076

(22) Filed: Apr. 25, 2006

(51) Int. Cl. G06F 15/173

(52) U.S. Cl. 709/223

(57) ABSTRACT

An apparatus and method are disclosed for configuring a workflow. An apparatus that incorporates teachings of the present disclosure may include, for example, a computing device having a controller programmed to identify one or more active objects from a content source, and structure the one or more active objects into a workflow having a networking topology and a plurality of operational paradigms. Additional embodiments are disclosed.

### RELATED APPLICATIONS

U.S. patent application, filed Mar. 30, 2006, by Bolger et al., entitled “Message-Oriented Divergence and Convergence of Message Documents,” incorporated herein by reference in its entirety.

U.S. patent application, filed Apr. 25, 2006, by Yang et al., entitled “Method and Apparatus for Importing Content in a User-Defined Workflow,” incorporated herein by reference in its entirety.

U.S. patent application, filed Apr. 25, 2006, by Yang et al., entitled “Method and Apparatus for Defining a Workflow,” incorporated herein by reference in its entirety.

### FIELD OF THE DISCLOSURE

The present disclosure relates generally to workflow techniques, and more specifically to a method and apparatus for configuring a workflow.

### BACKGROUND

The Internet and other means of mass communications have made it extraordinarily simple to distribute large amounts of content to end users. Managing high volumes of content in a manner that can be acted on in a productive manner can be challenging. Applications such as Microsoft's Windows Explorer and Internet Explorer provide a means for end users to manage such content under independent operational paradigms.

With Internet Explorer for instance an end user can browse content between remote servers in a well defined operational paradigm managed in part by a Hyper Text Transfer Protocol or HTTP. Windows Explorer on the other hand allows end users to browse elements of one or more file systems (e.g., files, folders, or directories) under another operation paradigm managed in part by Microsoft's NT File System (NTFS) protocol. Although these paradigms can be made to interact, there is no unique way for an end user to readily define combinations of these and other operational paradigms in a configurable workflow.

A need therefore arises for a method and apparatus for configuring a workflow.

### BRIEF DESCRIPTION OF THE DRAWINGS

FIG. 1 depicts an exemplary embodiment of a communication system;

FIG. 2 depicts an exemplary embodiment of one or more computing devices operating in the communication system;

FIG. 3 depicts an exemplary method operating in or more of the computing devices;

FIGS. 4-5 depict exemplary illustrations of networking topologies applied to the embodiments of the method illustrated in FIG. 3; and

FIG. 6 depicts exemplary illustrations of graphical user interfaces (GUIs) corresponding to the embodiments of the method illustrated in FIG. 3; and

FIG. 7 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for configuring a workflow.

In a first embodiment of the present disclosure, a computer-readable storage medium can have computer instructions for structuring content into one or more active objects having a plurality of operational paradigms, applying a networking topology selected by an end user to the structured content thereby generating a workflow, and presenting one or more graphical user interfaces (GUIs) of the workflow according to the networking topology.

In a second embodiment of the present disclosure, a computing device can have a controller programmed to identify one or more active objects from a content source, and structure the one or more active objects into a workflow having a networking topology and a plurality of operational paradigms.

In a third embodiment of the present disclosure, a method can generate a workflow having a network topology of one or more active objects derived from content having a plurality of operational paradigms.

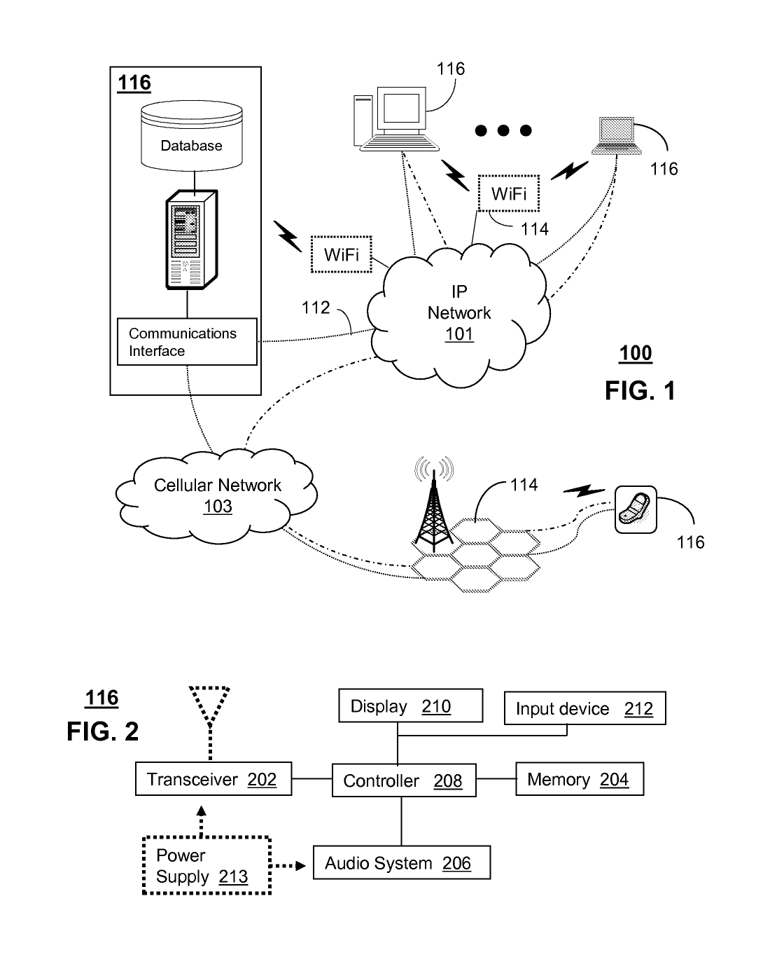

FIG. 1 depicts an exemplary embodiment of a communication system 100. The communication system 100 can comprise a plurality of computing devices (CD) 116 represented by any number of embodiments including a desktop computer, a cellular phone, a laptop computer, or a scalable server coupled to wired and/or wireless access points 112, 114.

Wired access points 114 can comprise a plain old telephone services (POTS) interface, a digital subscriber line (DSL) interface, a cable data communications interface, an optical communications interface, a T-carrier line (T1, T2, etc.) or any other suitable means for wired communications. The wired access points 114 can carry voice and/or data communications according to the present disclosure.

The wireless access points 114 can be depicted by a number of embodiments including a plurality of cellular base stations supporting wireless voice and/or data communications in a cellular network 103, and/or one or more Wireless Fidelity (WiFi) access points operating in a commercial enterprise, retail store, residence, or otherwise. The cellular network 103 can utilize circuit-switched technology that supports voice and data services such as GSM-GPRS, EDGE, CDMA-1X, EV/DO, UMTS, and other known and next generation cellular communications technologies. The cellular network 103 utilizes a frequency-reuse architecture for communicating over-the-air with roaming CDs 116 over an expansive area. The WiFi access points can conform to any one of IEEE's 802.11 present and next generation protocols (e.g., IEEE 802.11a, b, g, n) and can operate individually or in a mesh network.

Alternatively, or in combination, other wireless access technologies can be applied to the present disclosure such as, for example, a Worldwide Interoperability for Microwave Access (WiMAX), ultra wide band (UWB), Bluetooth™, and software defined radio (SDR). SDR provides a means to access public and private communication spectrum with any number of communication protocols that can be dynamically downloaded over-the-air to the CD 116. Other present and future generation wireless access technologies can also be used in the present disclosure.

The communication system 100 can further comprise an IP (Internet Protocol) network 101 that couples to the CDs 116 for carrying Internet traffic therebetween. In yet another embodiment of FIG. 1 (not shown), the IP network 101 can be replaced with an Intranet network or a common local area network (LAN) in which case the CDs 116 and a number of access points 114 (e.g., WiFi's and/or Ethernet ports) operate within an enterprise or residential environment according to the present disclosure.

FIG. 2 is an exemplary block diagram of the CD 116. The CD 116 can utilize a common wired transceiver 202 coupled to any of the aforementioned wired interface technologies (e.g., a POTS modem, a DSL modem, a cable modem, etc.). Alternatively, or in combination the CD 116 can include short range wireless communications technology in the transceiver 202 such as used by cordless phones, Bluetooth or WiFi devices to support mobility within a small area such as the end user's residence or enterprise.

The transceiver 202 can be further supplemented with technology that supports mid to long-range wireless communications with the wireless access points 114 by way of cellular, WiMAX, or SDR technologies. The CD 116 can also operate as a multimode device. That is, when the CD 116 is within a building it can perform communication activities over a wired DSL interface, a POTS interface, WiFi, or Bluetooth™ interfaces, and so on. One or more of these interfaces can in turn support data communications, Voice over IP (VoIP) communications by way of the IP network 101, and POTS voice messaging. When roaming outside the building, the CD 116 can exchange data and voice messages over the cellular network 103 or other long-range networks such as WiMAX.

Each of the foregoing embodiments for the CDs 116 can utilize a memory 204, an audio system 206, and a controller 208 among other possible components. The memory 204 can comprise storage devices such as RAM, SRAM, DRAM, and/or Flash memories. The memory 204 can be external or an integral component of the controller 208. The audio system 206 can be utilized for exchanging audible signals with an end user. The CD 116 can further include a display 210 for conveying images to the end user, an input device 212 (such as a keypad and mouse) for manipulating operations of the CD 116, and a portable power supply 213. The audio system 206, the display 210, and the input device 212 can singly or in combination represent a user interface (UI) for controlling operations of the CD 116 as directed by the end user. The controller 208 can manage the foregoing components by utilizing computing technology such as a microprocessor and/or digital signal processor.

In a distributed processing environment, the controller 208 can represent a plurality of processors. Under this embodiment a computing device may be described as a laptop computer representing a first processor interacting with a server as a second processor each performing a variety of tasks that collectively produce an end result. Accordingly, the present disclosure can be applied to a single processing unit operating in a centralized computing environment, or a plurality of processing units in a decentralized computing environment which singly or in combination represent a computing device.

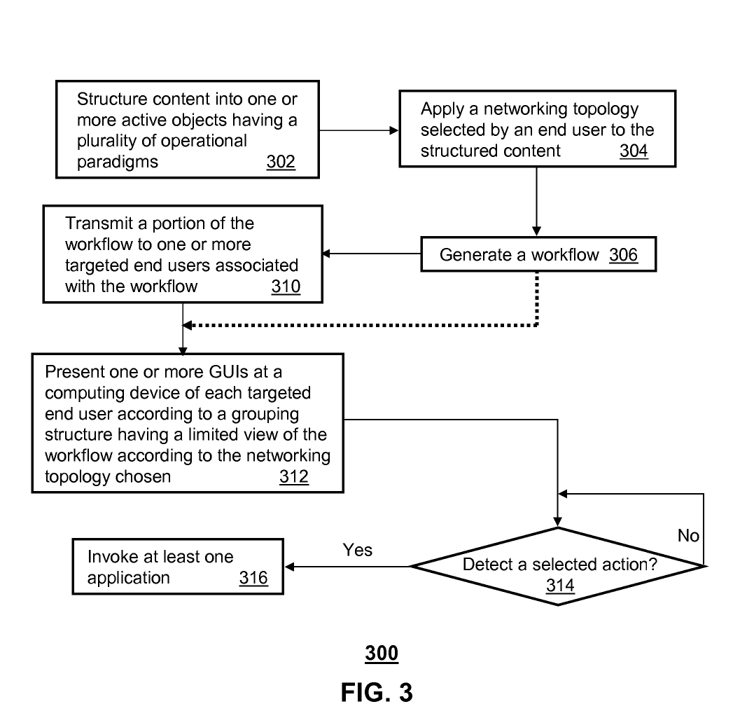

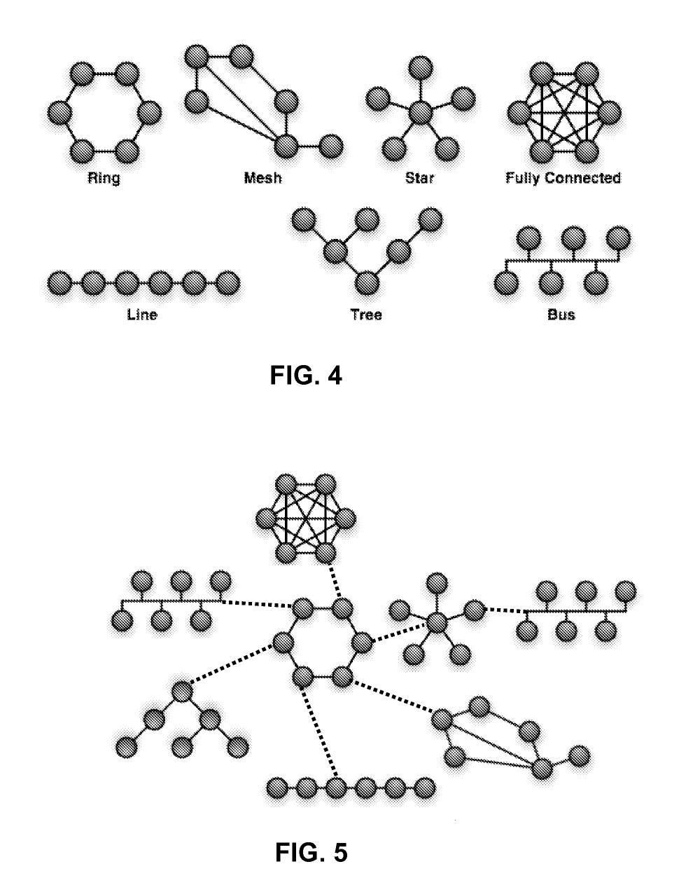

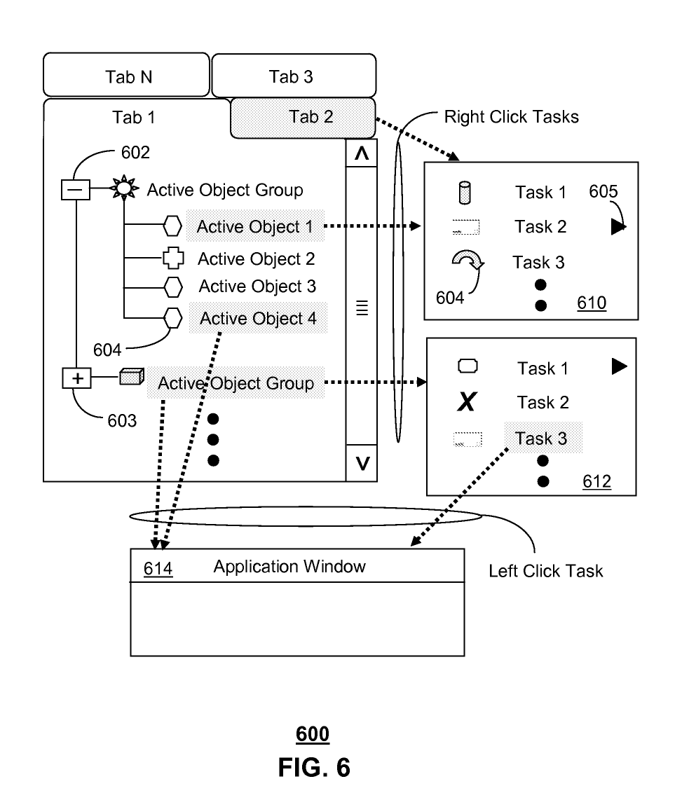

FIG. 3 depicts an exemplary method 300 operating in the CDs 116, while FIG. 6 depicts an illustration of graphical user interfaces (GUIs) 600 corresponding to embodiments of method 300 according to a networking topology selected from FIGS. 4-5. Method 300 can begin with step 302 in which the controller 208 can be programmed to structure content into one or more active objects having a plurality of common operational paradigms. In step 304 the controller 208 can be programmed to apply a networking topology (such as shown in FIGS. 4-5) selected by an end user to the structured content. As shown in FIG. 4, the end user can select from a number of topologies which can include without limitation a ring, mesh, star, fully connected, line, tree, or bus topology. Alternatively, the end user can select combinations of topologies as shown in FIG. 5. The topologies can be presented to the end user graphically for application to the structured content, or the end user can logically arrange the structure of active objects into a select one of the topologies.

Upon applying a select topology from FIG. 4 or 5 to the structured content, a workflow can be generated in step 306. A portion of the workflow can be transmitted in step 310 to one or more targeted end users associated with the workflow. In step 312, one or more GUIs can be presented at a computing device of each targeted end user according to a grouping structure having a limited view of the workflow in accordance with the topology applied in step 304.

Assume by way of example that the end user in step 304 selects a star topology (also commonly referred to as a hub and spoke topology—see FIG. 4). Further assume that the active objects selected from a content source represent individuals with actionable information associated with each individual (e.g., an email address, an instant messaging or IM address, a VoIP phone number, a mobile phone number, and so on). Further assume the hub (or center node) of the star represents the end user selecting the topology in step 304 while the spoke nodes represent active objects of other individuals. Under this topology, the end user at the hub can be presented with one or more GUIs that provide visibility and communication accessibility to the individuals at the spokes, while the individuals at the spokes can be presented with one or more GUIs with visibility and communication accessibility to only the individual at the hub.

The foregoing arrangement can be useful in applications where the individual assigned to the hub serves as a liaison between individuals at the spokes. That is, the individuals at the spokes can only communicate with others through the hub. Once the star topology has been applied to the structured content in step 304, portions of the resulting workflow can be submitted to the corresponding members of the star topology. Said members will each be presented in step 312 with a grouping structure such as a hierarchical structure depicted in one or more GUIs as shown in FIG. 6 in accordance with the limited view provided by the topology chosen. For the hub individual for instance she or he will see a hierarchy or group comprising all the individuals at the spokes, while the individuals at each spoke only see the hub party (i.e., a one level hierarchy with one party).

There are innumerable topologies or combinations of topologies that the end user can apply. The topology selected can depend on the particular use case desired. For instance, in a work project environment a bus structure can be suitable for sharing information between team members. The bus structure can be combined with nodes on a star to create independent work project teams managed by the hub (e.g., manager). Alternatively, individuals can be aligned in a line topology workflow that follows a sequential path much like a manufacturing line in which a product is sequentially developed from node to node. Depending on the topology chosen, a number of GUIs can be presented to a respective number of end users, each GUI having a view of the workflow affected by the topology applied in step 304.

It should be noted that although a hierarchical view is presented for the GUI 600 of FIG. 6, other grouping structures can be used without departing from the scope of the claims listed below. For instance, a cluster-oriented grouping structure can be used so that end users can arrange their own logical mapping of active objects. End users can create a cluster of active objects similar to the way icons can be grouped on a desktop as logical clusters. Accordingly, a grouping structure applied to GUI 600 can represent any containment format suitable to an end user interacting with said GUI. For illustration purposes only, the present disclosure focuses on hierarchical structures.

Referring back to step 302, the content referred to in this step can comprise without limitation any form of actionable content such as an email address (e.g., xxx.yyy@zzz.com), an instant messaging (IM) address (e.g., xxx.yyy@zzz.com), a domain name (e.g., zzz.com), a hyperlink (e.g., “News” hyperlink in Google), a web page (e.g., http://www.google.com/), a file system link to for example an image file, a Word file, a Zip file, a Power Point file, an Excel file, a directory, a folder, and so on.

The above content types can be managed in a number of operational paradigms such as, for example, a file system browsing paradigm (e.g., Microsoft Windows Explorer), a remote server browsing paradigm (e.g., Microsoft Internet Explorer), an operating system management paradigm (e.g., Microsoft Windows XP), a data management paradigm (e.g., a database, a customer relationship management application), and a communications management paradigm (e.g., circuit-switched voice communications, VoIP communications, short message service or SMS communications, email, instant messaging, chat room messaging, and so on). The aforementioned workflow of step 306 can operate singly or in combination with any of these operational paradigms in a grouping structure of active objects presented in step 312 to an end user by way of one or more related GUIs as shown in FIG. 6.

This is a significant paradigm shift from prior art systems. Prior art systems such as Microsoft Internet Explorer and Microsoft Windows Explorer utilize operational paradigms with independent workflows. For instance, Microsoft Internet Explorer provides a single operational paradigm in which an end user can browse content between remote servers by way of the Internet. Microsoft Windows Explorer on the other hand provides a single operational paradigm in which an end user can browse content in a local or remote file system utilizing a common directory structure.

Although the operational paradigms of Windows Explorer and Internet Explorer can share some resources, the end user has no flexibility to redefine these paradigms such as by combining them into a single workflow having a limited topological view according to a topology selected by the end user in FIG. 4 or 5. Accordingly, an end user cannot without significant difficulty extensively browse the Internet from Windows Explorer, nor can an end user without similar difficulty extensively explore a file system by way of Internet Explorer in accordance with a selected networking topology. Similarly, these applications cannot be readily redefined to create a communications management paradigm such as by invoking an instant messaging application from within the same operational paradigm. Other prior art systems such as found in Linux and Apple™ computing systems have similar limitations.

With these limitations in mind, the reader's attention is directed back to FIG. 6. In this illustration, the hierarchical structure can have as many levels of active objects as desired. The active objects as noted earlier can be email addresses, IM addresses, file system links, chat room addresses, SMS email addresses, a person's office number, cell phone number, and so on. Although these active objects can be used in independently operated paradigms such as described earlier, the hierarchical structure of FIG. 6 provides the end user a novel means to combine operational paradigms in a single workflow.

Tab 1 for example can represent a workflow. Within this tab the active objects can be grouped in a nested or flat structure. In a nested structure, a group of active objects (i.e., an active object group) can have a logical representation. For example, one group of active objects can logically represent a chat room, another a file system, another an instant messaging list, another a work project group, another a web link group, and so on. The active objects of each active object group can also have a logical association with each other. For instance, a chat room group can have active objects representing members of the chat room, an instant messaging group can have a grouping of instant messaging contacts, a work project group can have members belonging to a specific work project team, a web link group can have a grouping of web links having a logical association (such as music hyperlinks, news hyperlinks, entertainment hyperlinks, etc.).

Alternatively, the active object groups can have hybrid associations. For instance, an active object group representing a work project group may have a list of members, each member having nested active objects representing the member's cell phone number, office number, work address, home address, home number, email address, IM address, short message service (SMS) address, work project files relating to the member's assigned tasks, and so on. Such a structure can provide the end user of the team a powerful means for associating with each of the other members of the work project team.

The active object groups and/or its sub elements (i.e., its active objects) can be affected by the networking topology applied in step 304. For instance in the work project team example discussed above, the members of the work project team can have a limited view in which communication with other work project teams must take place by way of the hub.

Each active object can also have an associated iconic symbol 604 to assist an end user in visually identifying an active object type. Similarly, iconic symbols 604 can be used to identify tasks that can be applied to the active object as a selectable actions associated with one or more task menus 610, 612.

The hierarchical structure can have an expansion icon 602, a collapse icon 603, and a nested icon 605. As noted earlier, each tab can represent a workflow defined by the end user according to a selected networking topology. Each workflow can therefore represent portions of the hierarchical structure apportioned to each tab by the end user. It should be further evident from the illustration of FIG. 6 that any level of the hierarchical structure can serve as an active object. Accordingly, an end user can selectively perform an action on a tab, on an active object group, and/or an active object.

Selections can take place graphically by way of a common mouse integrated in the input device 212 having, for example, two selectable buttons (a left and right button). To assist the selection process, tabs, active object groups, and active objects can be named by the end user as desired or by the controller 208. In the latter case, for example, the controller 208 can be programmed to extract Joe Smith from an email address such as Joe. Smith@company.com, and thereby name the active object Joe Smith as a representation of said email.

A tab, an active object group, or an active object can be selected by placing a mouse pointer over any of these objects and left clicking or right clicking the mouse buttons. Upon detecting in step 314 a single or double click of the left button using common software and hardware techniques, the controller 208 can be programmed in step 316 to invoke a default application associated with the type of active object selected.

For example, in a case where an active object represents a person having communication information associated therewith, the controller 208 can be programmed to invoke an IM application as a default application that presents a separate GUI window 614 to the end user to begin an instant messaging session with the selected individual. Alternatively, other applications can be defined as a default application. For instance, instead of invoking an IM application, the controller 208 can be programmed to invoke a chat room application. A default application can be defined by the end user or an administrator of method 300.

The aforementioned default application can be invoked by soliciting one or more applications by way of an operating system managing the resources of the CD 116, or by other common means for initiating an application. It should be noted that an application in the present context can mean software, hardware or combinations thereof.

In yet another embodiment, the controller 208 can detect in step 314 a right click of the mouse button on a selected active object. In this instance, a more extensive list of selectable actions can be presented to the end user (see references 610, 612). The tasks listed in 610 or 612 can depend on the active object selected. Additionally, tasks within these menus can be nested (see reference 605). To select a task the end user can place the mouse pointer over a desired task and select an action with a left click of the mouse button which in turn can invoke in step 316 an application window 614 or cause an update of the hierarchical structure without a displayable GUI. In the latter case, an application window 614 may not be necessary for common tasks such as deleting an active object (e.g., delete a member from a chat room).

Method 300 can invoke innumerable applications in accordance with the present disclosure. For instance, an application in the present context can represent without limitation an operating system application, a paging application or short message service (SMS) application, an email application (e.g., Microsoft Outlook), an instant messaging application (e.g., MSN Messenger), a chat room application, an editing application (e.g., Microsoft Word), a spreadsheet application (e.g., Microsoft Excel), a presentation application (e.g., Microsoft Power Point), a document formatting application (e.g., Adobe Acrobat), a browser application (e.g., Microsoft Internet Explorer), a statistical application, a database application (e.g., Oracle, or Microsoft Access), a voice messaging application (e.g., a voice POTS or VoIP call), a video application (e.g., Microsoft NetMeeting, Microsoft Windows Media Player), or a file system application (e.g., Microsoft Windows Explorer), just to name a few.

Alternatively, said applications can be in whole or in part an integral aspect of method 300. For instance, computer instructions corresponding to method 300 can include an instant messaging application in which case an instant messaging session can be invoked without requesting said application by way of an operating system. Accordingly, method 300 can comprise any number of internal applications which can be invoked in real-time. External applications on the other hand can be invoked by method 300 by way of an operating system.

Thus method 300 can be utilized for any number of applications such as for example transmitting pages to cell phone users upon selecting a task in GUI 610, invoking voice and/or video messaging session between end users, and/or forwarding to new or existing members one or more tabs, an active object group within a tab, or portions thereof by email or other data transfer means.

Method 300 can also be used for publishing and sharing portions of the hierarchical structure 600 of FIG. 1 between members of a particular active object group, or between active object groups. For instance, an active object group designated as Work Project Team A can share portions of active objects in its group with Work Project Team B of another active object group, and vice-versa. Additionally, method 300 can be used for selecting an active object such as a person and invoke an application that retrieves information about the person from a corporate directory or a local information source such as contact entries in Microsoft Outlook, Lotus Notes, and so on.

For an active object group representing a chat room, the end user can also use method 300 to select a task such as to attend a chat room meeting, or view a conversation history from a selectable list of previous chat room sessions. An end user can also apply method 300 to view the properties of a tab, active object group, or an active object such as for instance its file size, application type, and so on, by selecting a task in menus 610 or 612.

When application 614 is invoked in response to an end user selecting an active object or task associated therewith, the application 614 can be programmed to display portions of the hierarchical structure concurrently thereby providing the end user additional selectable options such as for example forwarding portions of the hierarchical structure to targeted parties, sending individual or broadcast emails, or SMS messages, sending invitations to other members of the active object group to begin an IM or chat room session, and so on. Each task menu 610, 612 can also display a help task to assist the end user when s/he needs assistance understanding the function of a displayed task.

It should be evident to an artisan with ordinary skill in the art that the uses for a grouping structure of active objects having one or more operational paradigms configured by a networking topology as described above can have endless variants and therefore cannot all be described in the present disclosure. For instance, a number of applications can be programmed to supply information status to one or more of the active objects of FIG. 6. The application can be operating on a remote server which provides status information (such as available for use or “active”, or unavailable for use or “inactive”). The status information can in turn be used as a variant of method 300 to dynamically change the icon associated with one or more of the active objects thereby notifying the end user of the active object's status. It would be apparent therefore to said artisan that the embodiments disclosed herein can be rearranged, modified, reduced, or enhanced without departing from the scope and spirit of the claims described below. The reader is therefore directed to the claims for a fuller understanding of the breadth and scope of the present disclosure.

It should be further noted that although the present disclosure refers to Microsoft applications such as Microsoft's Internet Explorer and Window's Explorer any other Internet browser application and/or file system shell can be applied to method 300 as described above within the scope of the claims described below.

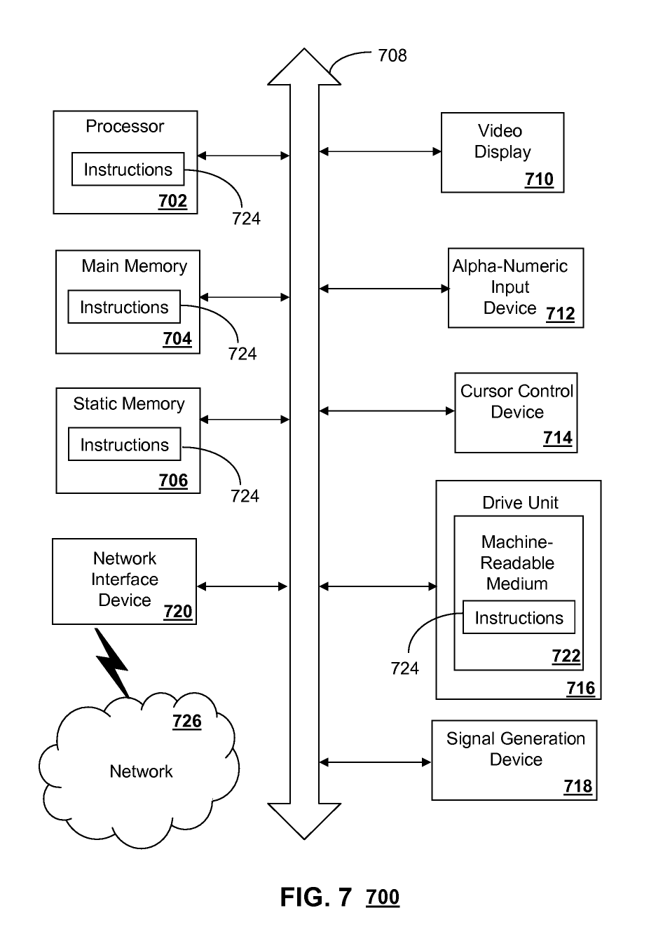

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to email or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
structuring content into one or more active objects having a plurality of operational paradigms;
applying a networking topology selected by an end user to the structured content thereby generating a workflow; and
presenting one or more graphical user interfaces (GUIs) of the workflow according to the networking topology.

2. The storage medium of claim 1, comprising computer instructions for invoking at least one application in response to a selected action applied to a portion of the workflow.

3. The storage medium of claim 1, wherein the networking topology comprises at least one among a group of topologies comprising a ring topology, a mesh topology, a star topology, a fully connected topology, a line topology, a tree topology and a bus topology.

4. The storage medium of claim 3, wherein the networking topology comprises a hybrid of one or more topologies from the group of topologies.

5. The storage medium of claim 1, wherein communication between the active objects is limited by the networking topology.

6. The storage medium of claim 1, comprising computer instructions for presenting a nested view of the GUIs.

7. The storage medium of claim 1, wherein the one or more active objects are associated with one or more end users, and wherein the storage medium comprises computer instructions for transmitting a portion of the workflow to a select one of the end users for presenting another GUI having a limited view of the workflow according to the selected end user's position in the workflow.

8. The storage medium of claim 7, wherein the GUI presented to the selected end user comprises a grouping structure corresponding to the limited view of the workflow.

9. The storage medium of claim 1, wherein the plurality of operational paradigms comprise at least two among a file system browsing paradigm, a remote server browsing paradigm, an operating system management paradigm, a data management paradigm, and a communications management paradigm.

10. The storage medium of claim 8, comprising computer instructions for detecting a selected action on at least one among a level of the grouping structure, and one or more of the active objects of the grouping structure.

11. The storage medium of claim 10, comprising computer instructions for detecting the selected action as one or more tasks applied to the grouping structure.

12. The storage medium of claim 11, comprising computer instructions for presenting at least one additional GUI corresponding to the one or more tasks associated with the selected action.

13. The storage medium of claim 8, comprising computer instructions for adjusting the GUI in response to a request by the end user to expand or collapse a view of one or more levels of the grouping structure.

14. A computing device, comprising a controller programmed to:
identify one or more active objects from a content source; and
structure the one or more active objects into a workflow having a networking topology and a plurality of operational paradigms.

15. The computing device of claim 14, wherein the controller is programmed to present a graphical user interface (GUI) of the workflow according to the networking topology.

16. The computing device of claim 14, wherein the networking topology comprises at least one among a group of topologies comprising a ring topology, a mesh topology, a star topology, a fully connected topology, a line topology, a tree topology and a bus topology.

17. The computing device of claim 14, comprising a transceiver, wherein the one or more active objects are associated with one or more end users, and wherein the controller is programmed to transmit a portion of the workflow to a select one of the end users for presenting another GUI having a limited view of the workflow according to the selected end user's position in the workflow.

18. The computing device of claim 17, wherein the GUI presented to the selected end user comprises a hierarchical structure corresponding to the limited view of the workflow.

19. The computing device of claim 14, wherein the controller comprises a plurality of processors each programmed to perform different portions of the foregoing steps, and wherein the plurality of processors operate in a distributed network.

20. A method, comprising generating a workflow having a network topology of one or more active objects derived from content having a plurality of operational paradigms.

21. The method of claim 20, wherein the networking topology comprises at least one among a group of topologies comprising a ring topology, a mesh topology, a star topology, a fully connected topology, a line topology, a tree topology and a bus topology.

22. The method of claim 20, wherein the one or more active objects are associated with one or more end users, and wherein the method comprises transmitting a portion of the workflow to a select one of the end users for presenting another GUI having a limited view of the workflow according to the selected end user's position in the workflow.
